(19) United States
(12) Patent Application Publication
(10) Pub. No.: US 2013/0181654 A1
(43) Pub. Date: Jul. 18, 2013

(54) MOTOR DRIVE SYSTEM EMPLOYING AN ACTIVE RECTIFIER

(71) Applicants: Gregory I. Rozman, Rockford, IL (US); Thomas A. Duclos, Suffield, CT (US); Duane A. James, Middletown, CT (US)

(72) Inventors: Gregory I. Rozman, Rockford, IL (US); Thomas A. Duclos, Suffield, CT (US); Duane A. James, Middletown, CT (US)

(73) Assignee: HAMILTON SUNDSTRAND CORPORATION, Windsor Locks, CT (US)

(21) Appl. No.: 13/352,793

(22) Filed: Jan. 18, 2012

(51) Int. Cl. H02P 27/00

(52) U.S. Cl. 318/721

(57) ABSTRACT

An active rectifier controller controls operation of an active rectifier employed in a power conversion system that supplies a direct current (DC) output to an inverter that converts the DC output to an AC output supplied to an AC motor. The active rectifier controller includes a field-oriented control (FOC) controller that monitors an alternating current (AC) input currents provided to the active rectifier, the DC output provided to the inverter, and speed of the AC motor. The FOC controller selects a reference DC output value based on the speed of the AC motor and compares the monitored DC output to the reference DC output as part of the FOC control algorithm used to generate control signals. A PWM signal generator generates PWM signals for controlling the active rectifier based on the control signals.

### STATEMENT OF GOVERNMENT INTEREST

This invention was made with government support under N65540-08-D-0017 DO 0001 awarded by the United States Navy. The government has certain rights in the invention.

### BACKGROUND

The present invention is related to active rectifiers, and in particular to active rectifiers used in conjunction with motor drives.

Active rectifiers are commonly employed in motor drive systems to convert alternating current (AC) line voltage to a direct current (DC) voltage. The DC output voltage provided by the active rectifier is converted to an AC output having a desired phase and frequency for supply to an AC motor. Active rectifiers are designed to draw sinusoidal currents from the three-phase input power supply and produce controlled DC bus voltage to power loads such as motor drive inverter(s). Undesirable characteristics of the PWM converter, such as dead time of the gate drive which is used to prevent the short circuit of power converter legs, turn on/off time of switching devices, and on-voltages of switching devices and diodes may not allow reduction of the input current harmonics to specified level.

Current ripples generated by the motor drive inverter may result in saturation of the AC motor at peak currents that adversely affects the torque generating capability of the AC motor. The current ripple is typically controlled by either increasing the switching frequency or employing an output filter to filter current ripple components. However, increasing the switching frequency increases the switching losses of the motor drive inverter, thereby reducing the efficiency of the system. Employing an output filter (e.g., inductor or LC-type filter) increases the overall weight of the system.

### SUMMARY

An active rectifier controller controls operation of an active rectifier employed in a power conversion system that supplies a direct current (DC) output to an inverter that converts the DC output to an AC output supplied to an AC motor. The active rectifier controller includes a field-oriented control (FOC) controller that monitors an alternating current (AC) input currents provided to the active rectifier, the DC output provided to the inverter, and speed of the AC motor. The FOC controller selects a reference DC output value based on the speed of the AC motor and compares the monitored DC output to the reference DC output as part of the FOC control algorithm used to generate control signals. A pulse width modulation (PWM) signal generator generates PWM signals for controlling the active rectifier based on the control signals.

### BRIEF DESCRIPTION OF THE DRAWINGS

FIG. 1 is a block diagram of a motor drive system according to an embodiment of the present invention.

FIGS. 2A and 2B are block diagrams illustrating functions performed by a pulse width modulation (PWM) converter controller according to an embodiment of the present invention.

FIG. 3 is a block diagram illustrating functions performed by a harmonic compensator employed by an active rectifier controller according to an embodiment of the present invention.

FIG. 4 is a block diagram illustrating function performed by 5^{th} order harmonic compensator according to an embodiment of the present invention

### DETAILED DESCRIPTION

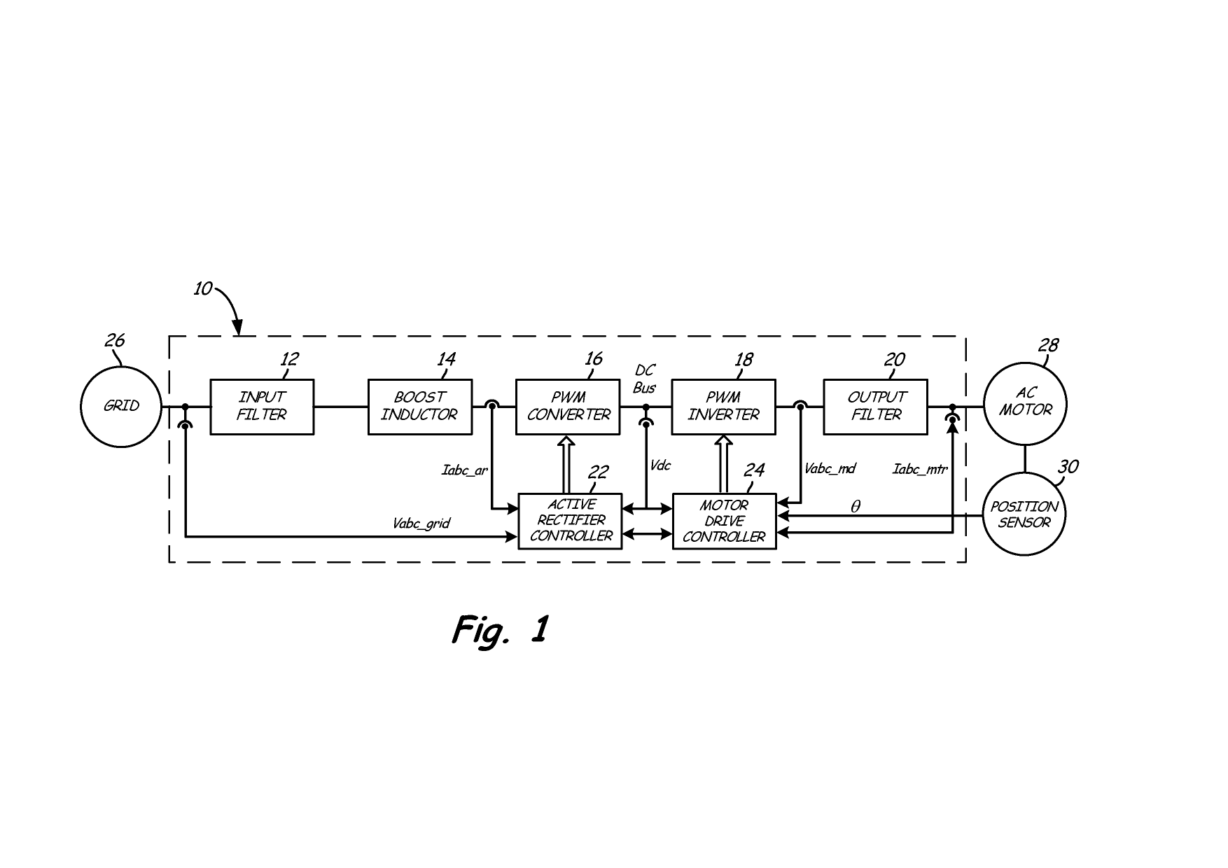

FIG. 1 is a block diagram of power conversion system 10 according to an embodiment of the present invention. Power conversion system 10 includes input filter 12, boost inductor 14, PWM converter 16, pulse width modulation (PWM) inverter 18, output filter 20, active rectifier controller 22, and motor drive controller 24.

In the embodiment shown in FIG. 1, power conversion system 10 converts AC line power received from grid 26, to an AC output having a desired phase and frequency for supply to AC motor 28. In particular, power conversion system converts the AC line power to a DC output via an active rectifier that includes input filter 12, boost inductor 14, PWM converter 16, and active rectifier controller 22, and PWM inverter 18 converts the DC output provided via a DC link to an AC output supplied to AC motor 28. Input filter 12 filters current ripples or harmonics generated by power conversion system 10 to prevent undesirable harmonics from being provided to grid 26.

PWM converter 16 includes a plurality of solid-state (i.e., active) switching devices that are selectively turned On and Off to convert the AC input provided by boost inductor 14 to a DC output provided on the DC link. Active rectifier controller 22 monitors the DC output voltage provided on the DC link Vdc, the input current(s) iabc_ar provided to PWM converter 16, and grid voltage Vabc_grid. This embodiment assumes three-phase AC input provided by grid 26, although in other embodiments single phase or multi-phase AC inputs may be employed. In addition, in the embodiment shown in FIG. 1, active rectifier controller receives input from motor drive controller 24. Based on these inputs, active rectifier controller 22 provides command signals to PWM controller 16 to control the state of solid-state switching devices (not shown). In one embodiment, active rectifier controller 22 receives motor speed information from motor drive controller 24, and based on the received motor speed information selectively modifies a reference DC voltage value that is not shown in FIG. 1 compared to the monitored DC link voltage Vdc. In one embodiment, the reference DC voltage value is increased as the speed of AC motor 28 increases.

PWM inverter 18 includes a plurality of solid-state (i.e., active) switching devices that are selectively turned On and Off to convert the DC voltage provided by the DC link to an AC output having the desired phase and frequency for supply to AC motor 28. Motor drive controller 24 monitors the AC output current(s) iabc_mtr provided to the motor windings of AC motor 28, position information θ provided by position sensor 30 (or derived via sensorless control), AC output voltage Vabc_md, and the DC link voltage Vdc. Based on these inputs, motor drive controller 24 generates command signals provided to PWM inverter 18 to control the state of solid-state switching devices (not shown).

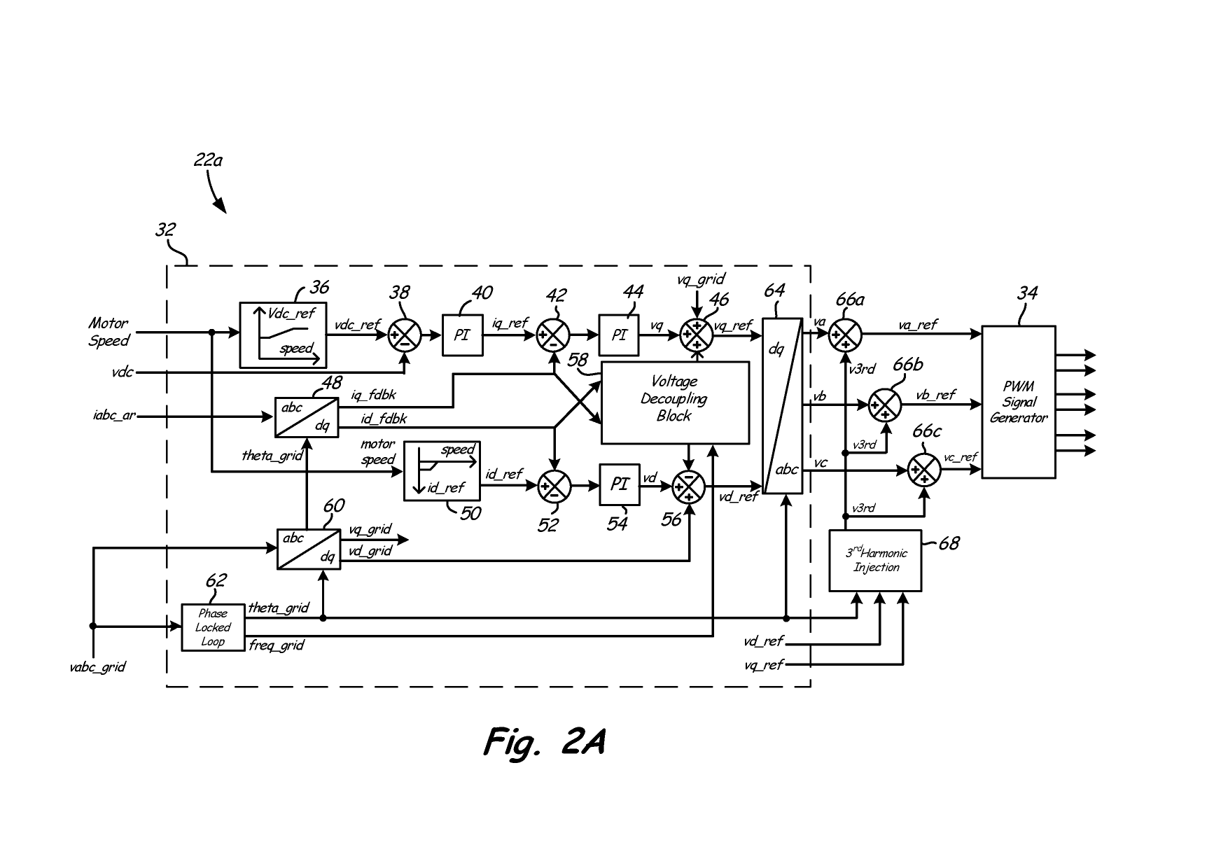

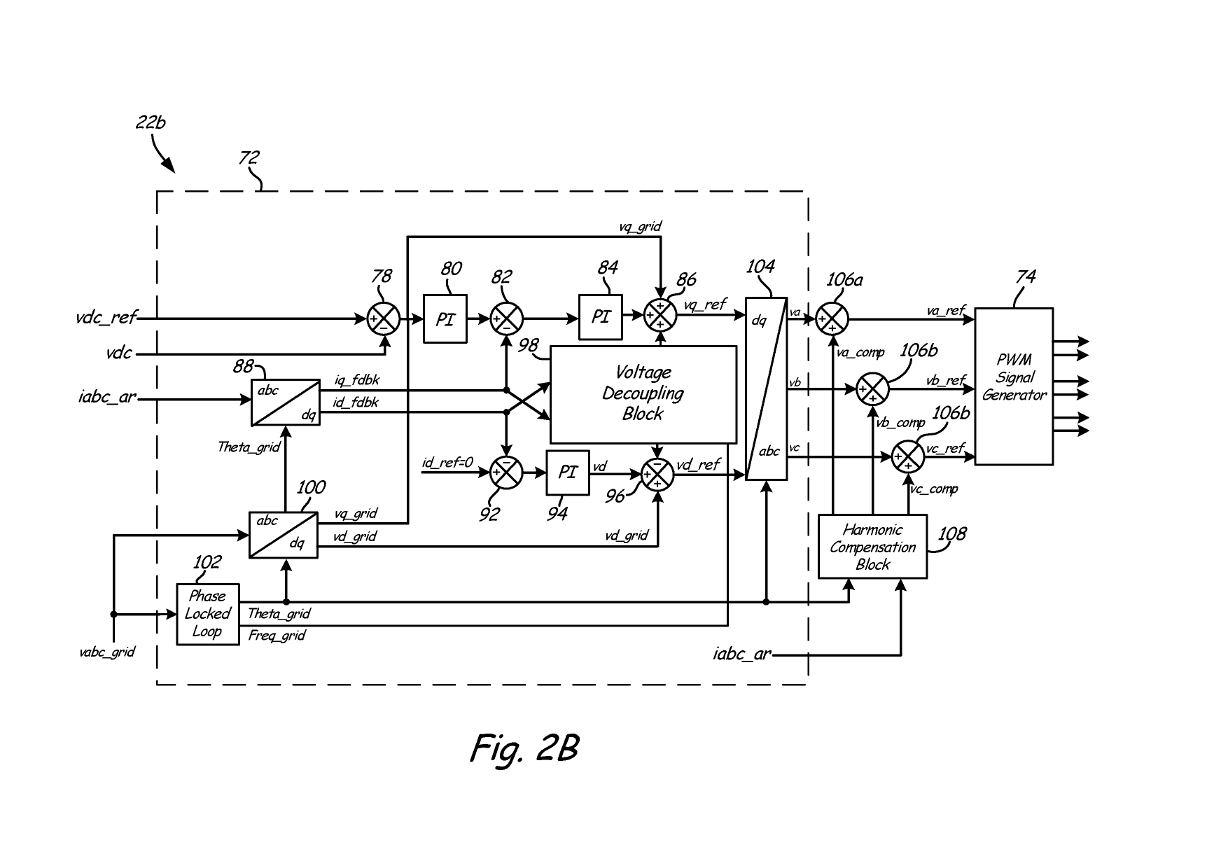

FIG. 2A is a block diagram illustrating functions performed by active rectifier controller 22a according to one embodiment of the present invention, and more specifically reduction of dc bus voltage at low speed to improve motor drive performance. In general, active rectifier controller 22a acts to regulate DC voltage provided by PWM converter 16 to PWM inverter 18 to a desired magnitude. In addition, active rectifier controller 22a reduces ripples in the current provided by PWM inverter 18 to AC motor 28 by selectively varying the desired magnitude based on the speed of AC motor 28. Decreasing the magnitude of the DC voltage at lower motor speeds, where back electromotive force (BEMF) is small, reduces current ripple generated by PWM inverter 18. At higher motor speeds, the DC voltage is increased in order to support the motor currents required to provide positive torque to AC motor 28.

In the embodiment shown in FIG. 2A, active rectifier controller 22a employs field oriented control (FOC) unit 32 to generate voltage command signals va, vb, vc that are provided to PWM signal generator 34 to generate the desired command instructions for each of the plurality of solid-state switching devices employed by PWM converter 16. In general, FOC control converts alternating current (AC) inputs from a three-phase, stationary reference frame in which the inputs vary sinusoidally to a two-phase dq reference frame that allows the AC inputs to be manipulated as DC components. In the embodiment shown in FIG. 2A, FOC unit 32 includes look-up table 36, comparator 38, proportional-integral (P-I) controller 40, comparator 42, P-I controller 44, summer 46, abc-to-dq converter 48, look-up table 50, comparator 52, P-I controller 54, summer 56, voltage decoupling block 58, abc-to-dq converter 60 and phase-locked loop (PLL) 62.

Inputs provided to active rectifier controller 22a includes motor speed provided by motor drive controller 24, monitored AC input currents iabc_ar, monitored grid voltage vabcgrid, monitored DC bus voltage vdc, and DC bus reference voltage vdc_ref. Motor speed information is provided to look-up table 36, which based on the provided motor speed selects a desired DC reference voltage Vdc_ref. As shown in FIG. 2A, the DC reference voltage vdc_ref increases with increasing speed of the motor. Comparator 38 compares the selected DC reference voltage vdc_ref to monitored DC voltage value vdc to generate an error signal that indicates the difference between the desired DC reference value and the actual DC voltage vdc. PI controller 40 acts to correct the error between the desired DC reference value and the actual DC voltage vdc by generating q-axis reference signal iq_ref, which represents the q-axis current required to generate the desired DC voltage vdc_ref.

Monitored AC current iabc_ar (representing three monitored phase currents ia, ib, ib) is converted from three-phase abc components to two-phase dq components, represented as iq_fdbk and id_fdbk by abc-to-dq converter 48. Comparator 42 compares q-axis feedback component iq_fdbk with q-axis reference signal iq_ref. The difference or error between the q-axis feedback component iq_fdbk and q-axis reference signal iq_ref represents the difference between the monitored q-axis current iq_fdbk and the desired q-axis current iq_ref. This difference is provided to PI controller 44, which generates in response q-axis voltage command signal vq, which represents the q-axis voltage required to reduce the error between the monitored q-axis current iq_fdbk and the desired q-axis current i_{d—}ref.

Monitored AC grid voltage vabc_grid (representing three monitored phase voltages va, vb, vc) is converted from three-phase abc components to two-phase dq components, represented as vq_grid and vd_grid, by abc-to-dq converter 60. Comparator 46 compares the monitored q-axis grid voltage vq_grid to the q-axis voltage command signal vq provided by PI controller 44. In addition, voltage decoupler block 58 provides a voltage decoupling output based on monitored dq current components iq_fdbk and id_fdbk. A voltage decoupling output is added to comparator 46, and a separate voltage decoupling output is subtracted from comparator 56.

Similarly, a d-axis voltage command vd_ref is generated based on monitored motor speed, phase currents iabc_ar, and grid voltages vabc_grid. Motor speed information provided by motor drive controller 24 is provided to d-axis look-up table 50, which selects a d-axis reference current value id_ref based on the monitored motor speed. In one embodiment, the d-axis reference current is negative at low motor speeds, and increases and is maintained at zero at higher motor speeds. A negative d-axis reference current at low motor speeds maintains leading power factor correction useful at low motor speeds for generating maximum torque and to ensure stable operation of the active rectifier that includes input filter 12, boost inductor 14 and PWM converter 16.

Comparator 52 compares the d-axis reference current id_ref to d-axis feedback current idjdbk calculated by abc-to-dq converter 48. The error or difference calculated by comparator 52 represents the difference between the desired d-axis current id_ref and the actual d-axis current idjdbk. Based on this difference or error signal, PI controller 54 generates a d-axis voltage command vd that is compared with the d-axis grid voltage vd_grid by comparator 56. Voltage decoupling block 58 also contributes a decoupling value that is subtracted from the difference between the d-axis reference voltage vd and the d-axis grid voltage vd_grid.

Monitored grid voltage vabc_grid is provided to phase locked loop (PLL) 62 to calculate electrical phase angle θ and frequency information ω associated with the grid voltage. Electrical phase angle information is employed by abc-to-dq converters 48, 60 to convert from the three-phase abc reference frame to the two-phase dq reference frame, and by dq-to-abc converter 64 to convert d-axis and q-axis voltage commands vd_ref and vq_ref from the dq reference frame to the abc reference frame. Electrical phase angle information θ is also provided to 3^{rd} harmonic injection block 68 along with d-axis and q-axis reference voltage commands vd_ref and vq_ref. Harmonic injection block 68 generates a harmonic injection v3rd that acts to increase the fundamental voltage, the 3^{rd} harmonic injection improves active rectifier current regulation at lower dc bus voltage levels that allows further reduction of dc bus voltage at low motor speeds.

The q-axis reference voltage vq_ref and d-axis reference voltage vd_ref are converted from the dq reference frame to the abc reference frame by dq-to-abc converter 64. The harmonic compensation output v3rd is added to the three-phase reference voltages va, vb, and vc by summers 66a, 66b, and 66c, respectively, to generate three-phase reference voltages va_ref, vb_ref, and vc_ref. PWM signal generator 34 converts the three-phase reference voltages va_ref, vb_ref, and vc_ref to pulse width modulation signals that are provided to each of the plurality of solid-state switching devices within PWM converter 16.

FIG. 2B is a block diagram illustrating functions performed by active rectifier controller 22b according to one embodiment of the present invention, and more specifically reduction of input current harmonics. In general, active rectifier controller 22b acts to regulate DC voltage provided by PWM converter 16 to PWM inverter 18 to a desired magnitude. In addition, active rectifier controller 22b reduces input current harmonics by injecting sinusoidal voltage compensation signals va_comp, vb_comp, and vc_comp into the pulse-width modulation (PWM) voltage command signals.

Similar to the embodiment shown in FIG. 2A, the embodiment of active rectifier controller 22b shown in FIG. 2B employs field oriented control (FOC) unit 72 to generate voltage command signals va, vb, vc that are provided to PWM signal generator 74 to generate the desired command instructions for each of the plurality of solid-state switching devices employed by PWM converter 16. In the embodiment shown in FIG. 2B, FOC unit 72 includes comparator 78, proportional-integral (P-I) controller 80, comparator 82, P-I controller 84 summer 86, abc-to-dq converter 88, comparator 92, P-I controller 94, summer 96, voltage decoupling block 98, abc-to-dq converter 100 and phase-locked loop (PLL) 102.

Inputs provided to active rectifier controller 22b includes monitored AC input currents iabc_ar, monitored grid voltage vabc_grid, monitored DC bus voltage vdc, and DC bus reference voltage vdc_ref. In the embodiment shown in FIG. 2B, DC reference voltage vdc_ref is constant and does not vary based on changes in motor speed. However, the embodiment shown in FIG. 2B may be used in conjunction with the embodiment shown in FIG. 2A in which the magnitude of the DC bus reference voltage vdc_ref varies based on the monitored motor speed of AC motor 28.

Comparator 78 compares the DC reference voltage vdc_ref to monitored DC voltage value vdc to generate an error signal that indicates the difference between the desired DC reference value and the actual DC voltage vdc. PI controller 80 acts to correct the error between the desired DC reference value and the actual DC voltage vdc by generating q-axis reference signal iq_ref, which represents the q-axis current required to generate the desired DC voltage vdc_ref.

Monitored AC current iabc_ar (representing three monitored phase currents ia, ib, ib) is converted from three-phase abc components to two-phase dq components, represented as iq_fdbk and id_fdbk by abc-to-dq converter 88. Comparator 82 compares q-axis feedback component iq_fdbk with q-axis reference signal iq_ref. The difference or error between the q-axis feedback component iq_fdbk and q-axis reference signal iq_ref represents the difference between the monitored q-axis current iq_fdbk and the desired q-axis current iq_ref. This difference is provided to PI controller 84, which generates in response q-axis voltage command signal vq, which represents the q-axis voltage required to reduce the error between the monitored q-axis current iq_fdbk and the desired q-axis current iq_ref.

Monitored AC grid voltage vabc_grid (representing three monitored phase voltages va, vb, vc) is converted from three-phase abc components to two-phase dq components, represented as vq_grid and vd_grid, by abc-to-dq converter 100. Comparator 86 compares the monitored q-axis grid voltage vq_grid to the q-axis voltage command signal vq provided by PI controller 84. In addition, voltage decoupler block 98 provides a voltage decoupling output based on monitored dq current components iq_fdbk and id_fdbk. A voltage decoupling output is added to comparator 86, and a separate voltage decoupling output is subtracted from comparator 96.

Similarly, a d-axis voltage command vd_ref is generated based on phase currents iabc_ar and grid voltages vabc_grid. In the embodiment shown in FIG. 2B, the d-axis reference current id_ref is set equal to zero. However, the embodiment shown in FIG. 2B may be combined with the embodiment shown with respect to FIG. 2A in which the d-axis reference current id_ref is varied based on the monitored motor speed.

Comparator 92 compares the d-axis reference current id_ref to d-axis feedback current id_fdbk calculated by abc-to-dq converter 88. The error or difference calculated by comparator 52 represents the difference between the desired d-axis current id_ref and the actual d-axis current id_fdbk. Based on this difference or error signal, PI controller 94 generates a d-axis voltage command vd that is compared with the d-axis grid voltage vd_grid by comparator 96. Voltage decoupling block 98 also contributes a decoupling value that is subtracted from the difference between the d-axis reference voltage vd and the d-axis grid voltage vd_grid.

Monitored grid voltage vabc_grid is provided to phase locked loop (PLL) 102 to calculate electrical phase angle θ and frequency information w associated with the grid voltage. Electrical phase angle information is employed by abc-to-dq converters 88, 100 to convert from the three-phase abc reference frame to the two-phase dq reference frame, and by dq-to-abc converter 104 to convert d-axis and q-axis voltage commands vd_ref and vq_ref from the dq reference frame to the abc reference frame. Electrical phase angle information θ is also provided to harmonic compensation block 108 along with d-axis and q-axis reference voltage commands vd_ref and vq_ref. Harmonic compensation block 108 generates a three-phase harmonic compensation signals va_comp, vb_comp, and vc_comp that are added to the three-phase reference voltages va, vb, and vc, respectively by summers 106a, 106b, 106c, which acts to minimize harmonics associated with the active rectifier. For example, in one embodiment harmonic compensation block 108 minimizes 5^{th} and 7^{th} harmonics.

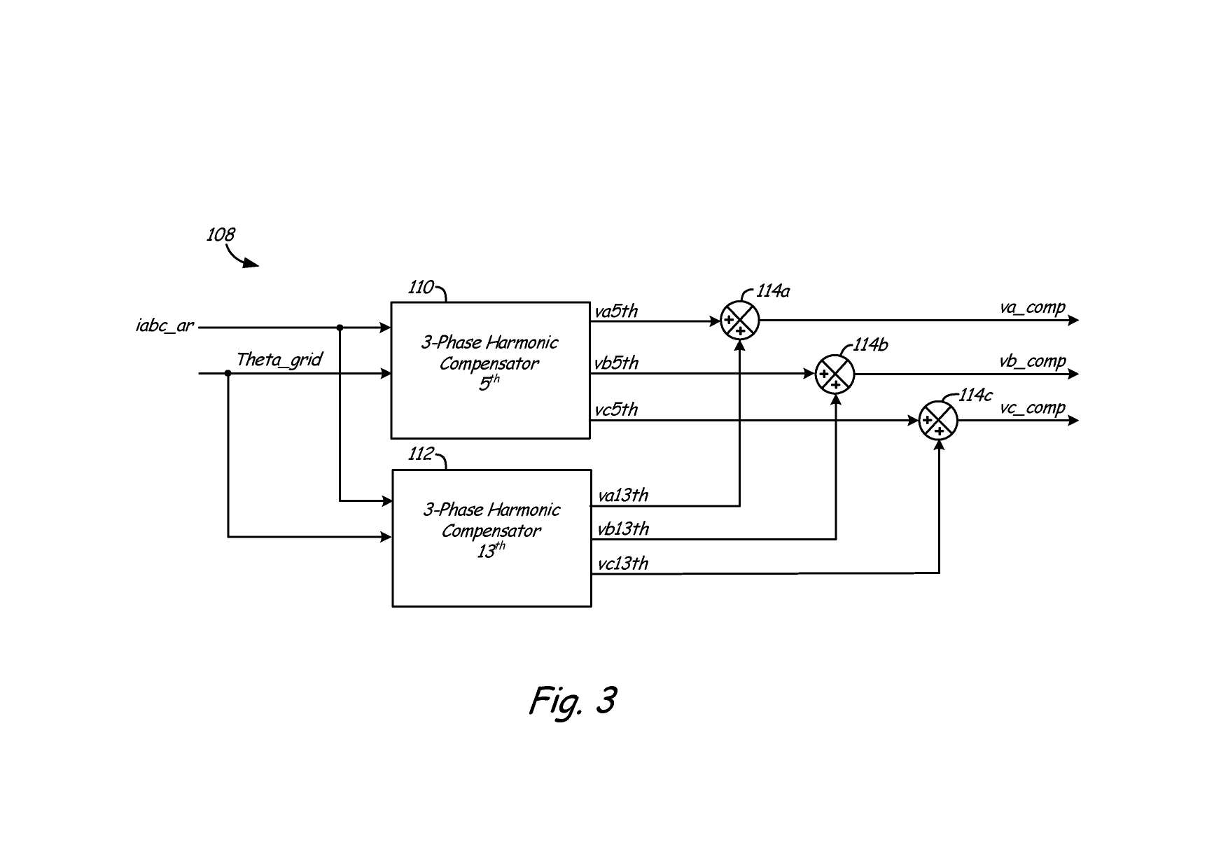

FIG. 3 is a block diagram illustrating functions performed by harmonic compensator 108 employed by active rectifier controller 22b according to an embodiment of the present invention. Harmonic compensator 108 is tuned to isolate harmonics (e.g., 5^{th} harmonic, 13^{th} harmonic) in the monitored three-phase currents iabc_ar and generate in response compensation signals that act to cancel out or minimize the isolated harmonics. In the embodiment shown in FIG. 3, harmonic compensator 108 includes 5^{th} harmonic compensator 110, 13^{th} harmonic compensator 112, and summers 114a, 114b, 114c.

In the embodiment shown in FIG. 3, 5^{th} harmonic compensator 110 receives the monitored three-phase current iabc_ar and phase information θ, and based on these inputs generates harmonic compensation signals va5th, vb5th, and vc5th. Likewise, 13^{th} harmonic compensator 112 receives the monitored three-phase current iabc_ar and phase information θ, and generates in response harmonic compensation signals va13th, vb13th, and vc13th. The harmonic compensation signals for each respective phase are added together by summers 114a, 114b, and 114c to generate harmonic compensation signals va_comp, vb_comp, and vc_comp.

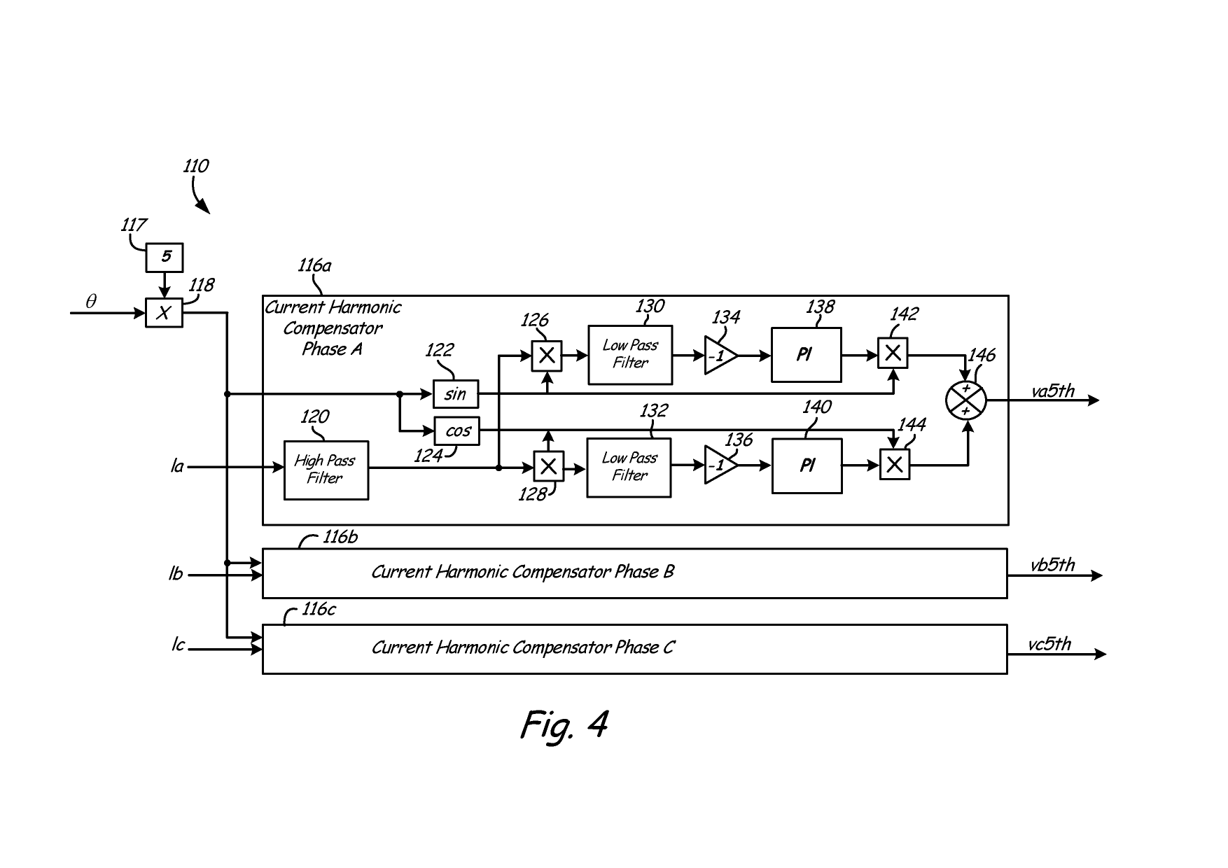

FIG. 4 is a block diagram illustrating function performed by 5^{th} harmonic compensator 110 according to an embodiment of the present invention. Harmonic compensator 110 includes phase-level harmonic compensator blocks 116a, 116b, and 116c. Each phase-level harmonic compensator block is associated with one phase of the monitored phase currents ia, ib, and ic. Multiplier 118 multiplies electrical phase angle information θ by the harmonic to be filtered 117 (in this case, the 5^{th} harmonic), and provides the product to each of the phase-level harmonic compensators 116a, 116b, and 116c.

The functions performed by phase-level harmonic compensator block 116a are described in detail with respect to the embodiment shown in FIG. 4, although phase-level harmonic compensator blocks 116b and 116c would include similar functionality. Phase-level harmonic compensator block 116a includes high-pass filter 120, sine function 122, cosine function 124, multiplier blocks 126 and 128, low-pass filters 130 and 132, inverter blocks 134 and 136, proportional-integral (PI) blocks 138 and 140, multiplier blocks 142 and 144, and summer block 146.

Monitored phase current ia is provided to high-pass filter 120 to isolate or select high-frequency components within the monitored phase current. A quadrature sine wave signal is synchronized with the selected harmonic (e.g., 5^{th} harmonic). Multiplier block 126 multiplies the sine wave signal with the high-frequency components provided by high-pass filter 120 to obtain the sine component of the 5^{th} harmonic ripple. Inverter 134 and PI controller 128 act to minimize the isolated harmonic (e.g., isolated 5^{th} harmonic) by providing compensated sine component of the 5^{th} harmonic vector. The compensated sine component is restored to sine wave form at multiplier block 142. Similar functions are performed with respect to the cosine component by multiplier block 128, low-pass filter 132, inverter 136, PI controller 140 and multiplier 144 with respect to the signal at the output of high pass filter 120. The respective compensated sine and cosine components provided by multiplier blocks 142 and 144 are summed by summer 146 and provided as compensated output va5th. Similar operations are performed with respect to phase-level harmonic compensator blocks 116b and 116c to generate isolated 5^{th} level harmonics vb5th and vc5th. In this way, total harmonic distortion (THD) content is reduced, in particular with respect to those harmonics created as a result of characteristics of the active rectifier that are difficult to reduce.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An active rectifier controller for controlling operation of a pulse width modulated (PWM) converter employed in a power conversion system that supplies a direct current (DC) output to an inverter that converts the DC output to an alternation current (AC) output supplied to an AC motor, the active rectifier controller comprising:
a field-oriented control (FOC) controller that monitors AC input currents provided to the PWM converter, the DC output provided to the inverter, and speed of the AC motor, wherein the FOC selects a reference DC output value based on the speed of the AC motor and compares the monitored DC output to the reference DC output to generate control signals; and
a pulse width modulation (PWM) signal generator that generates PWM signals for controlling the PWM converter based on the control signals.

2. The active rectifier controller of claim 1, wherein the reference DC output value selected by the FOC controller increases with increased speed of the AC motor.

3. The active rectifier controller of claim 1, wherein the FOC controller includes a look-up table that selects the reference DC output based on the speed of the AC motor.

4. The active rectifier controller of claim 1, wherein the FOC controller generates a q-axis reference current based on a difference between the monitored DC output and the selected reference DC output value and selects a d-axis reference current based on the speed of the AC motor.

5. The active rectifier controller of claim 4, wherein the d-axis reference current selected by the FOC controller is increased from a negative value to zero as the speed of the AC motor increases.

6. The active rectifier controller of claim 1, further including:
a dq-to-abc converter for converting a q-axis voltage reference and a d-axis voltage reference from a dq reference frame to an abc reference frame; and
a harmonic compensator that monitors the AC input currents provided to the PWM converter, selects harmonic components within the monitored AC input currents, and generates a compensation signal that minimizes the selected harmonic components.

7. The active rectifier controller of claim 6, wherein with respect to each monitored AC input current phase, the harmonic compensator selects harmonic content with a monitored AC phase current by selecting via a high-pass filter high-frequency components of the AC phase current, generating a quadrature sine wave signal synchronized with a selected harmonic, multiplying the high-frequency components of the AC phase current with the quadrature sine wave signal to obtain quadrature components of the selected harmonic within the monitored AC phase current, and applying a proportional-integral controller to generate a compensated component that drives the quadrature component of the selected harmonic to zero.

8. A method of controlling an active rectifier employed in a power converter system, wherein the active rectifier includes an input filter, boost inductor and pulse width modulated (PWM) converter that converts an alternating current (AC) input to a direct current (DC) output that is supplied to an inverter, wherein the inverter converts the DC output to an AC output provided to an AC motor, the method of controlling the active rectifier comprising:
monitoring an AC input current provided to the active rectifier, a DC output voltage supplied to the inverter; and a speed of the AC motor;
selecting a reference DC output voltage value based on the monitored speed of the AC motor;
comparing the monitored DC output voltage to the selected reference DC output voltage value to calculate an error signal;
generating pulse width modulation (PWM) signals for provision to the PWM converter based on the calculated error signal; and
modifying the selected reference DC output value as the speed of the AC motor changes.

9. The method of claim 8, further including:
converting the monitored AC input current from the abc reference frame to a q-axis current feedback component and a d-axis current feedback component employed in field oriented control (FOC);
calculating a q-axis reference current value based on the calculated error signal;
comparing the calculated q-axis reference current value to the q-axis current feedback component;
generating a q-axis voltage command based on the comparison of the calculated q-axis reference current value to the q-axis current feedback component;
selecting a d-axis reference current value based on the monitored speed of the AC motor;
comparing the selected d-axis reference current value to the d-axis current feedback component;
generating a d-axis voltage command based on the comparison of the selected d-axis reference current value to the d-axis current feedback component;
converting the q-axis voltage command and d-axis voltage command from the dq reference frame to the abc reference frame, wherein the q-axis voltage command and d-axis voltage command signals are employed to generate the PWM signals provided to the active rectifier; and
modifying the selected d-axis reference current value as the monitored speed of the AC motor changes.

10. The method of claim 9, further including:
selecting with respect to each monitored AC input current a particular order of harmonics to be canceled;
generating with respect to each monitored AC input current a harmonic compensation value that cancels the selected harmonic; and
adding the harmonic compensation value to voltage command signals provided in the abc reference frame.

11. The method of claim 10, wherein selecting with respect to each monitored AC input current a particular order of harmonics to be canceled includes multiplying monitored electrical phase angle information by the order of harmonic to be selected.

12. The method of claim 11, wherein generating with respect to each monitored AC input current a harmonic compensation value includes:
selecting via a high-pass filter high-frequency components of the AC phase current;
generating a quadrature sine wave signal synchronized with a selected harmonic;
multiplying the high-frequency components of the AC phase current with the quadrature sine wave signal to obtain quadrature components of the selected harmonic within the monitored AC phase current; and
applying a proportional-integral controller to generate a compensated component that drives the quadrature component of the selected harmonic to zero.

13. An active rectifier controller for controlling operation of an active rectifier that includes a pulse width modulated (PWM) converter connected to convert an alternating current (AC) input to a direct current (DC) output for consumption by a load, the active rectifier comprising:
a field-oriented control (FOC) controller that monitors AC input currents provided to the active rectifier, the FOC controller employing the monitored output currents in a current loop feedback that generates control signals; and
a harmonic compensator that selects harmonic content within the monitored AC phase current by selecting via a high-pass filter high-frequency components of the AC phase current, generates a quadrature sine wave signal synchronized with a selected harmonic, multiplies the high-frequency components of the AC phase current with the quadrature sine wave signal to obtain quadrature components of the selected harmonic within the monitored AC phase current, and applies a proportional-integral controller to generate a compensated component that drives the quadrature component of the selected harmonic to zero, wherein the compensated component is added to the control signal generated by the FOC controller to minimize the selected harmonic in monitored AC input currents.

14. The active rectifier controller of claim 13, wherein the FOC controller further monitors the DC output provided to the inverter and speed of the AC motor, wherein the FOC selects a reference DC output value based on the speed of the AC motor and compares the monitored DC output to the reference DC output to generate control signals.

15. The active rectifier controller of claim 14, further including:
a pulse width modulation (PWM) signal generator that generates PWM signals for controlling the active rectifier based on the control signals generated by the FOC controller and compensated component provided by the harmonic compensator.
